(19) United States
(12) Patent Application Publication
(10) Pub. No.: US 2018/0156952 A1
(43) Pub. Date: Jun. 7, 2018

(54) UV Plastic Object Protection System

(71) Applicant: Scott A. Butz, Fargo, ND (US)

(72) Inventor: Scott A. Butz, Fargo, ND (US)

(21) Appl. No.: 15/872,849

(22) Filed: Jan. 16, 2018

Related U.S. Application Data
(63) Continuation-in-part of application No. 14/926,413, filed on Oct. 29, 2015.
(60) Provisional application No. 62/074,258, filed on Nov. 3, 2014.

(51) Int. Cl. G02B 5/20; B65D 65/20; B65D 23/08; B65D 23/02; A01M 31/06; G02B 5/26

(52) U.S. Cl. CPC G02B 5/208; B65D 65/20; G02B 5/26; B65D 23/02; A01M 31/06; B65D 23/0814

(57) ABSTRACT

A UV plastic object protection system for protecting a plastic object and any contents of the plastic object from ultraviolet light. The UV plastic object protection system generally includes a plastic material mixed with a UV reflective material to reflect UV light to protect the plastic object and any contents within the plastic object. The UV reflective material may alternatively be attached to the exterior of the plastic object via a host material such as paint, dye, ink or adhesive label.

### CROSS REFERENCE TO RELATED APPLICATIONS

The present application is a continuation-in-part of U.S. application Ser. No. 14/926,413 filed on Oct. 29, 2015 (Docket No. REEL-020), which claims priority to U.S. Provisional Application No. 62/074,258 filed Nov. 3, 2014 (Docket No. REEL-018). Each of the aforementioned patent applications, and any applications related thereto, is herein incorporated by reference in their entirety.

### STATEMENT REGARDING FEDERALLY SPONSORED RESEARCH OR DEVELOPMENT

Not applicable to this application.

### BACKGROUND OF THE INVENTION

### Field of the Invention

The present invention relates generally to an ultraviolet light protection system and more specifically it relates to a UV plastic object protection system for protecting a plastic object and any contents of the plastic object from ultraviolet light.

### Description of the Related Art

Any discussion of the related art throughout the specification should in no way be considered as an admission that such related art is widely known or forms part of common general knowledge in the field.

Ultraviolet (UV) light is destructive to plastic, objects constructed of plastic and also the contents of a plastic object. For example, beverages such as pop or water contained within a plastic container are subject to damage and temperature increase by UV light passing through the plastic container (e.g. bottle). Plastic containers (e.g. plastic bottles) that include bisphenol A (BPA) may leach the BPA into the liquid within the plastic container when exposed to UV light. Furthermore, plastic bottles that do not include BPA may also leach BPA-like chemicals or synthetic estrogens into the liquids when exposed to UV light.

Because of the inherent problems with the related art, there is a need for a new and improved UV plastic object protection system for protecting a plastic object and any contents of the plastic object from ultraviolet light.

### BRIEF SUMMARY OF THE INVENTION

The invention generally relates to an ultraviolet light protection system which includes a plastic material mixed with a UV reflective material to reflect UV light to protect the plastic object and any contents within the plastic object. The UV reflective material may alternatively be attached to the exterior of the plastic object via a host material such as paint, dye, ink or adhesive label.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a flowchart illustrating the process of making a plastic object with the UV reflective material integrated into the plastic.

FIG. 2 is a side view of a plastic container with the UV reflective material integrated into the plastic.

FIG. 3 is a cross sectional view taken along line 3-3 of FIG. 2 illustrating the interior of the plastic container protected by the plastic container.

FIG. 4 is a side view of an alternative embodiment of the present invention having a UV reflective layer applied to the outside of the plastic container.

FIG. 5 is a cross sectional view taken along line 5-5 of FIG. 4.

FIG. 6 is a cutaway view of a layer of substrate having an adhesive for attachment to a plastic object and with a UV reflective layer attached to the side of the substrate opposite of the adhesive.

FIG. 7 is a side view of another alternative embodiment with the UV reflective material attached to the exterior surface of a koozie that removably surrounds the plastic object.

FIG. 8 is an upper perspective view of another alternative embodiment of the present invention comprised of a cooler.

### DETAILED DESCRIPTION OF THE INVENTION

### A. Overview.

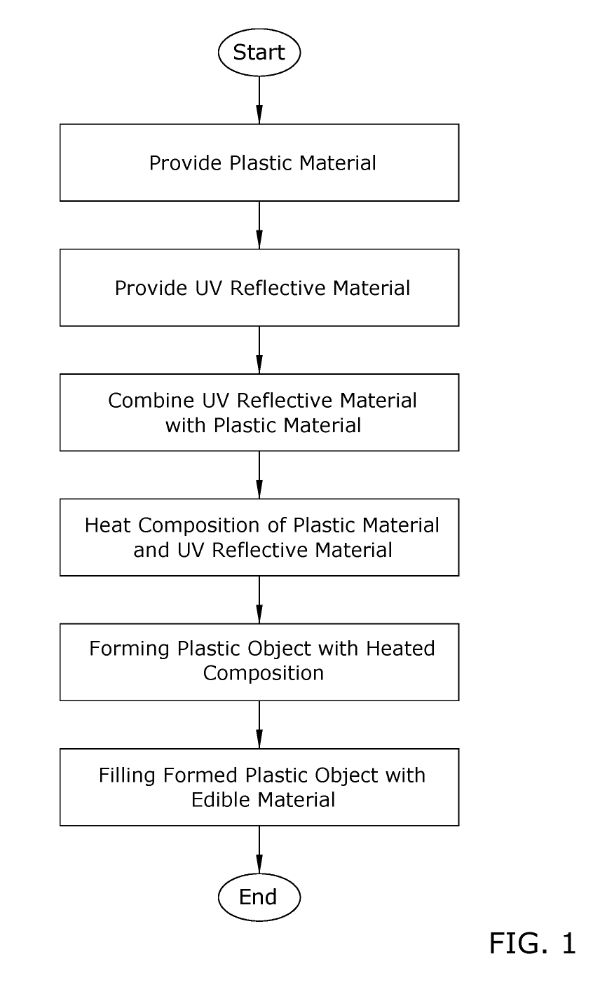

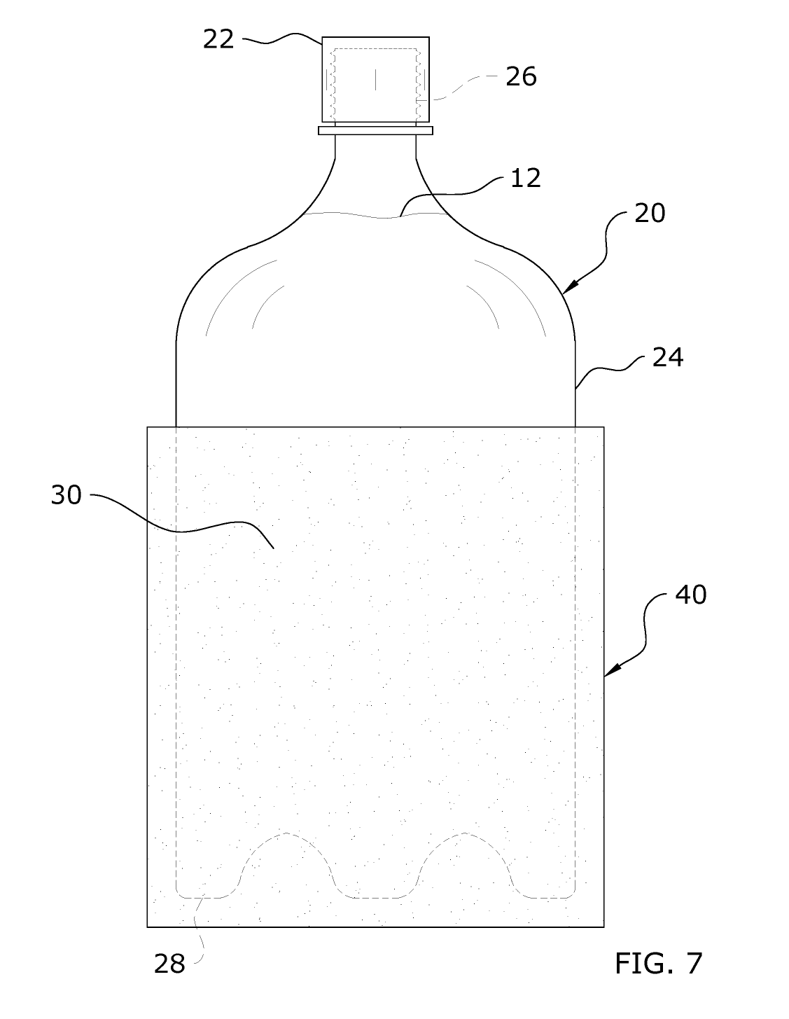

Turning now descriptively to the drawings, in which similar reference characters denote similar elements throughout the several views, FIGS. 1 through 8 illustrate a UV plastic object protection system, which comprises a plastic material mixed with a UV reflective material to reflect ultraviolet (UV) light to protect the plastic object 20 and any contents 12 within the plastic object 20. UV light is electromagnetic radiation with a wavelength shorter than that of visible light but longer than X-rays (from 400 nm to 10 nm in wavelength). UV light is typically not visible to humans, but can be seen by some children and young adults. The UV reflective material 30 may alternatively be attached to the exterior of the plastic object 20 via a host material such as paint, dye, ink or adhesive label. The UV reflective material 30 protects the plastic object 20 from damage, keeps the temperature of the plastic lower and also keeps the contents of the plastic object 20 (e.g. edible material 12 such as pop or water) at a lower temperature when exposed to UV light from the sun.

### B. Plastic Material.

The plastic material used for the present invention may be comprised of any well-known plastic material. The plastic material may be synthetic or semi-synthetic organic solids that are moldable. In a preferred embodiment of the present invention, the plastic material is derived from petrochemicals. The plastic material is typically initially provided in a particulate or pellet form which is then combined with the UV reflective material 30 prior to or after melting the plastic material thereby allowing the UV reflective material 30 to be thoroughly mixed with the plastic material prior to forming the plastic object 20.

### C. UV Reflective Material.

The UV reflective material 30 is added to the plastic material to provide the composition with desired UV reflective properties. The UV reflective material 30 forms a UV light protective layer around at least a portion of the plastic object 20 such as the sidewall. Only a portion of the plastic object 20 may include the UV reflective material 30 such as the sidewall 24.

It is emphasized that the UV reflective material 30 reflects ultraviolet (UV) light and does not absorb the UV light. The UV reflective material 30 may be a single substance or a combination of substances and may be formed in various colors as appreciated similar to the base substance. The UV reflective material 30 is preferably comprised of a nontoxic, biodegradable, edible, odorless substance that is able to mix with an oil-based plastic to form the composition.

In the preferred embodiment, the UV reflective material 30 is comprised of barium sulfate or similar substance. The barium sulfate is preferably pharmaceutical grade and is further preferably in powder form (e.g. crystalline solid) prior to mixing with the plastic material. The amount of UV reflective material 30 added to the plastic material depends upon the amount of UV light desired to be reflected by the plastic object 20. An increased percentage of UV reflective material 30 is used where the plastic container 20 will be exposed to an increased level of UV light or where the contents of the plastic container 20 require increased protection from UV light.

### D. Plastic Objects.

The present invention may be utilized for any plastic object 20 that is exposed to UV light from the sun. The present invention may be utilized to manufacture various types of plastic objects 20 such as, but not limited to, bottles, liquid containers, pitchers, baby bottles, juice bottles, food containers, coolers, koozies, PVC siding, window frames, door frames, pipes and gutters. In some embodiments, the plastic objects 20 may comprise hunting decoys which are typically used while hunting to attract various game being hunted. By way of example and without limitation, the plastic objects 20 could comprise water-fowl decoys. The present invention is particularly useful for protecting edible material 12 such as liquids (e.g. pop, water) and the like from exposure to UV light and leaked chemicals from the plastic container 20 when the plastic container 20 is exposed to UV light.

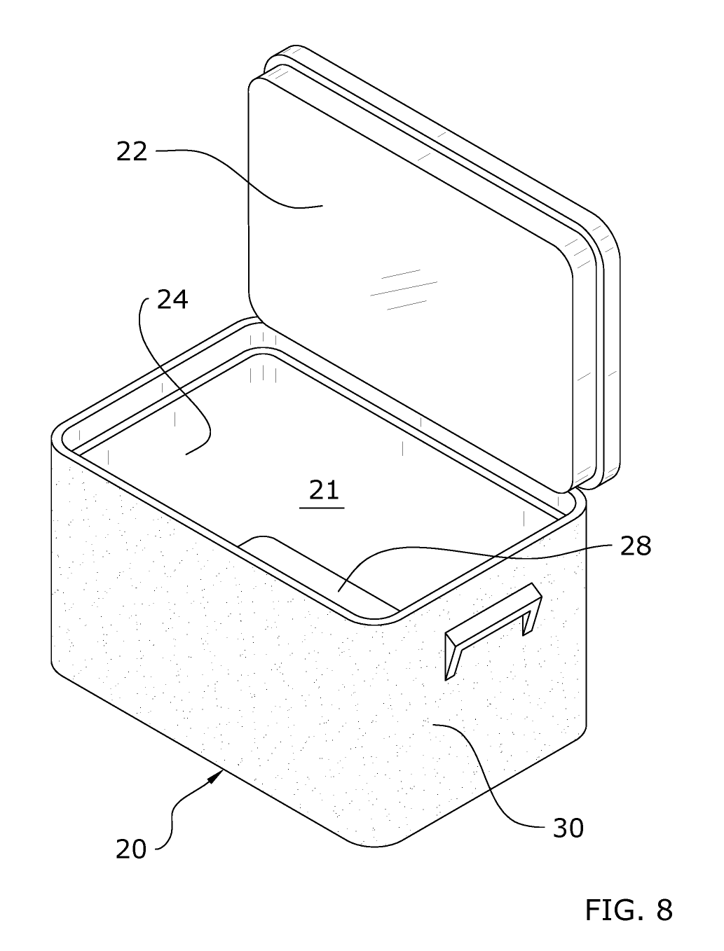

FIG. 8 illustrates the plastic container 20 being comprised of an exemplary cooler having a sidewall 24 and a floor 28 defining the interior space 21 along with a lid 22 pivotally attached to selectively enclose the interior space 21. The sidewall 24 and the lid 22 includes the UV reflective material 30 embedded within the plastic material used to construct the plastic container 20 constructed as a cooler. The UV reflective material 30 in the plastic material used for the cooler keeps the interior space 21 and food products cooler by reflecting the UV light.

E. First Embodiment—UV Reflective Material Integrated with Plastic Object. In the first embodiment shown in FIGS. 1 through 3 of the drawings, the plastic material is combined with the UV reflective material then heated into a liquid composition. The liquid plastic composition and UV reflective material is mixed thoroughly to ensure that the UV reflective material is adequately present throughout the plastic material. The liquid plastic is then used to construct a plastic object 20 such as a plastic container 20 via injection molding, rotational molding or other plastic molding process. The formed plastic object 20 (and any interior 21 contents) is protected from UV light by the UV reflective material within the plastic which reflects the UV light.

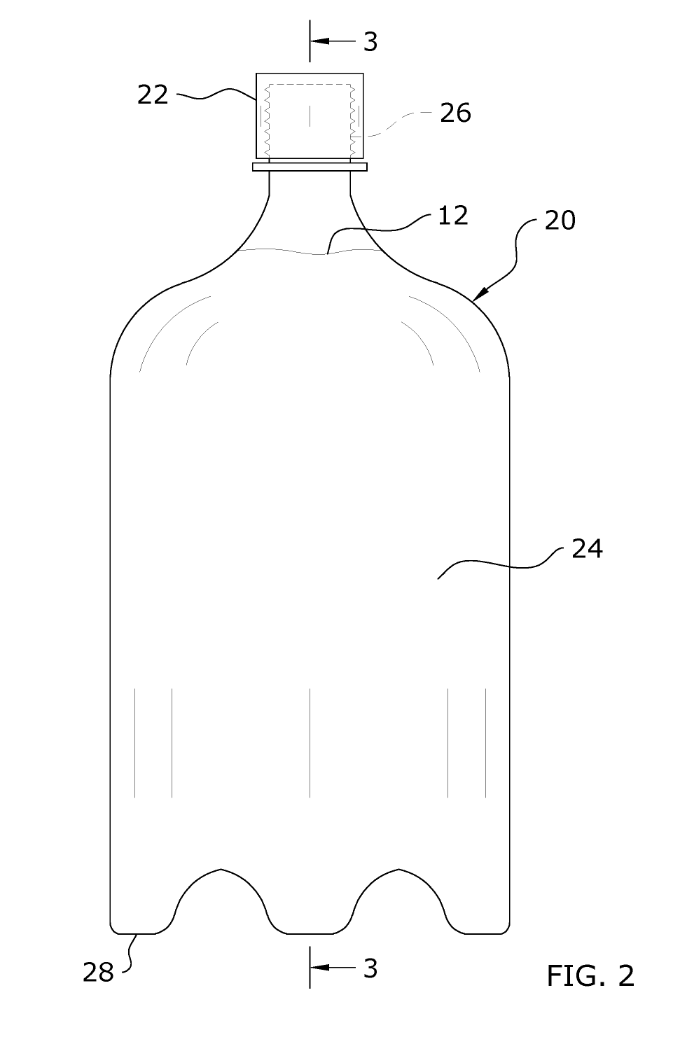

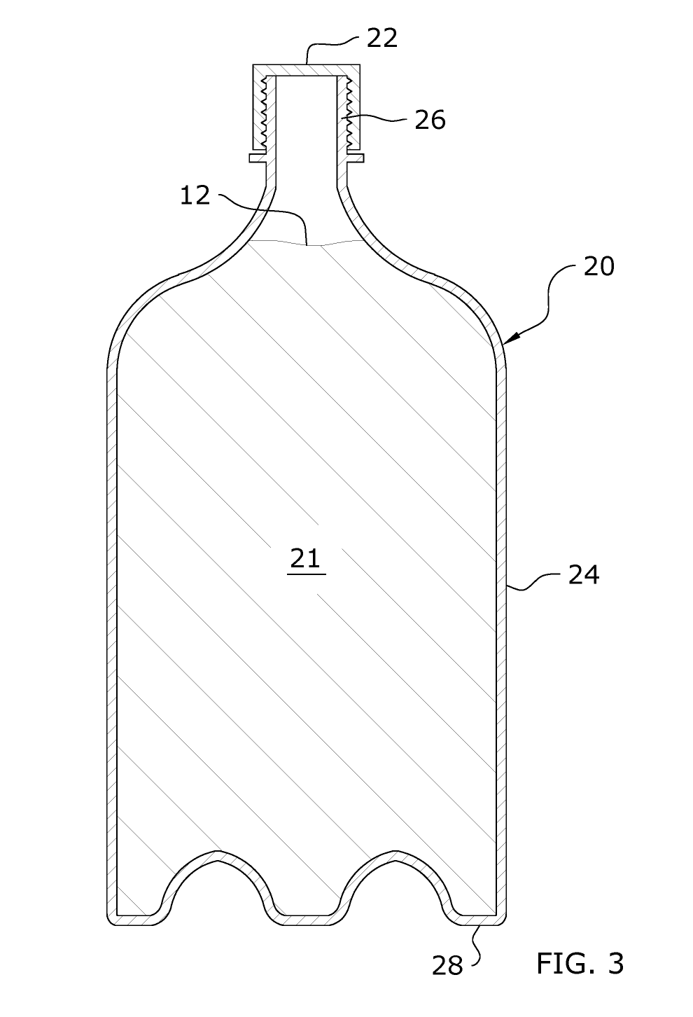

FIGS. 2 and 3 illustrate a plastic container 20 with the UV reflective material integrated into the plastic that forms the plastic container 20. The plastic container 20 may have various shapes and sizes suitable for containing a volume of edible material 12 such as pop, water, juice, milk and the like. For example, the plastic container 20 may have a bottle shape that has a sidewall 24, a neck 26, a cap 22 removably attached to the neck 26 and a bottom end 28 defining the interior 21 of the plastic container 20. When the UV light from the sun reaches the surface and interior 21 of the plastic container 20, the UV light is reflected away thereby reducing the amount of UV light that enters the interior 21 of the plastic container 20 along with reducing the temperature of the plastic container 20 and the edible material 12 within the plastic container 20.

### F. Second Embodiment—UV Reflective Material Applied to Surface of Plastic Object.

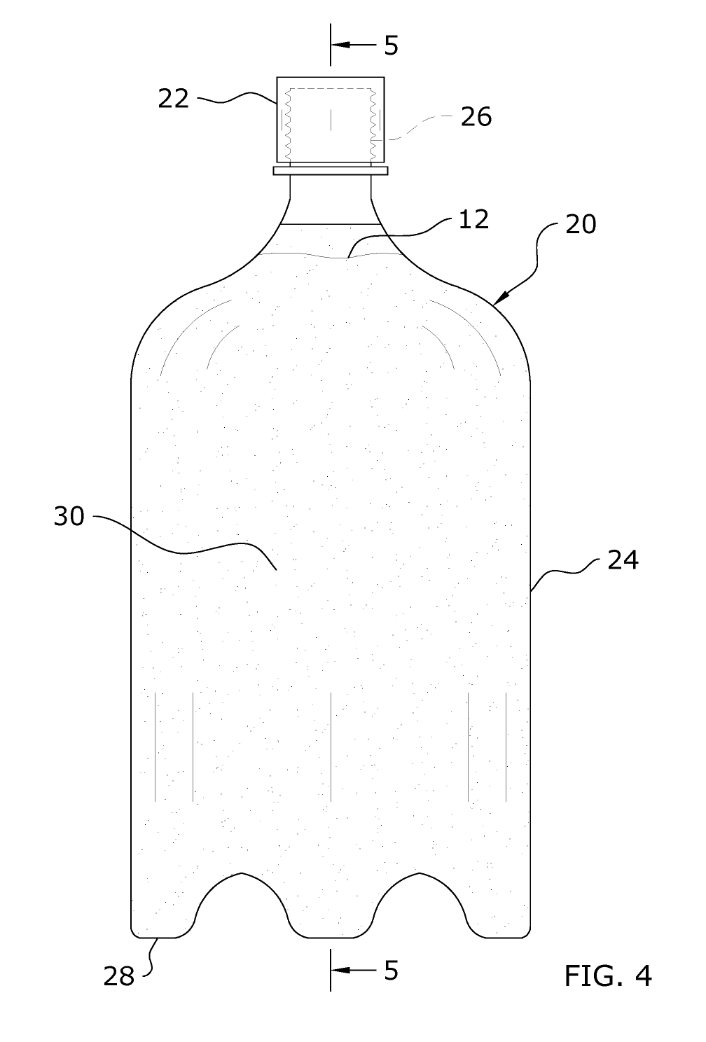

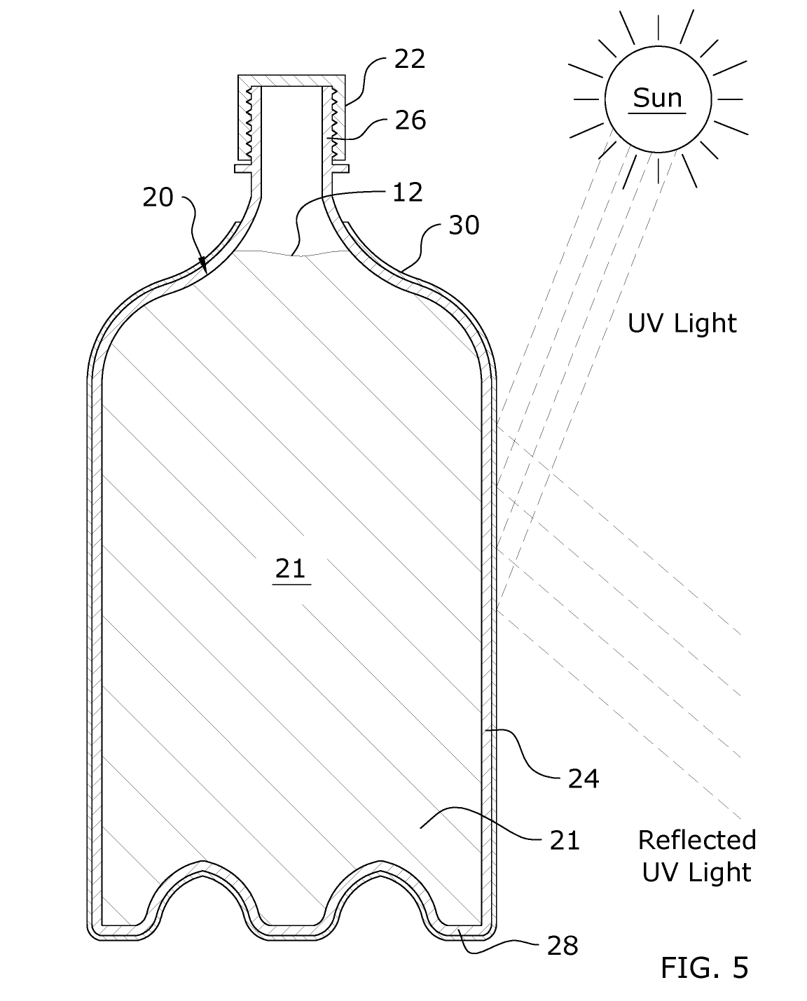

In a second embodiment of the present invention as illustrated in FIGS. 4 and 5 of the drawings, the UV reflective material 30 is applied and attached to the surface (exterior or interior 21) of the plastic object 20. It is preferable that the UV reflective material 30 is applied and attached to the exterior of the plastic object 20 to reduce the amount of UV light that penetrates the plastic which can result in the release of harmful chemicals into the edible material 12. The UV reflective material 30 may be mixed with various liquid based attachment materials for attachment to the exterior of the plastic object 20 such as paint (e.g. oil-based pain), ink, dye, glue, resin, lacquer, varnish and the like which is then applied to the exterior of the plastic object 20. Various processes for applying the UV reflective material 30 with the liquid based material may be used such as printing, painting and the like.

### G. Third Embodiment—UV Reflective Material Applied to Substrate.

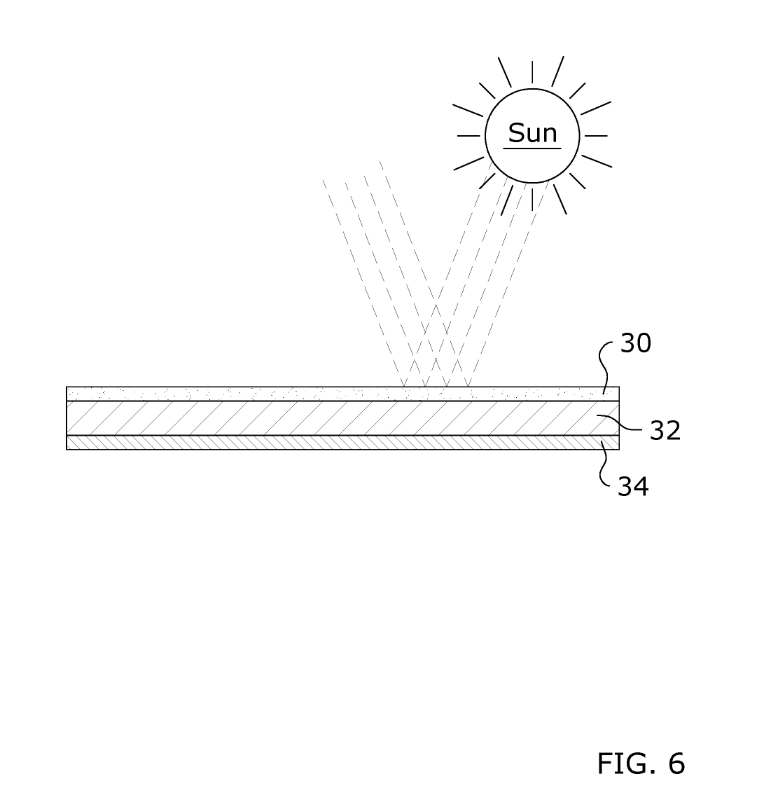

FIG. 6 illustrates a third embodiment of the present invention where the UV reflective material 30 is applied and attached to a surface of a substrate 32, wherein the substrate 32 is then attached to the exterior of the plastic object 20. The substrate 32 is preferably a flexible film and may be comprised of a transparent or semi-transparent material. It is preferable that the substrate 32 include an adhesive 34 on a side opposite of the UV reflective material 30 as shown in FIG. 6. The UV reflective material 30 may be applied to the substrate 32 similar to the second embodiment via a paint, ink, dye, glue and the like. The substrate 32 with the UV reflective material 30 is then attached to the exterior of the plastic object 20 (e.g. the sidewall 24 of the plastic container 20) thereby protecting the plastic object 20.

### H. Fourth Embodiment—UV Reflective Material Applied to Exterior of Holder.

In a fourth embodiment not illustrated in the figures, the UV reflective material may be applied to the exterior of a holder such as a koozie 40 that removably surrounds a plastic container 20 thereby protecting the koozie 40 and the plastic container 20 from the UV light. The UV reflective material may be applied to the exterior of the koozie 40 via an integral process such as in the first embodiment of the present invention or applied to the exterior of the koozie 40 via the process illustrated in the second embodiment of the present invention. The koozie 40 is comprised of an insulated sleeve material that in addition insulates the plastic object 20 and the edible material 12 within the plastic object 20.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A UV plastic object protection system, comprising:
a plastic object comprising an exterior and an interior, wherein the plastic object is comprised of a plastic material, wherein the plastic object is adapted to store a material within the interior of the plastic object; and
a UV reflective material attached to the plastic object, wherein the UV reflective material is adapted to reflect UV light away from the plastic object; and
wherein the UV reflective material is adapted to protect the material within the interior of the plastic object from exposure to UV light when the plastic object is exposed to UV light.

2. The UV plastic object protection system of claim 1, wherein the UV reflective material is attached to the exterior of the plastic object.

3. The UV plastic object protection system of claim 2, wherein the UV reflective material is adapted to protect the plastic object from exposure to UV light.

4. The UV plastic object protection system of claim 2, wherein the UV reflective material is mixed with an attaching material for attachment to the exterior of the plastic object.

5. The UV plastic object protection system of claim 4, wherein the attaching material is selected from the group consisting of glue, paint, ink, dye, resin, lacquer, or varnish.

6. The UV plastic object protection system of claim 4, wherein the UV reflective material is printed on the exterior of the plastic object.

7. The UV plastic object protection system of claim 4, wherein the UV reflective material is painted on the exterior of the plastic object.

8. The UV plastic object protection system of claim 4, wherein the UV reflective material is attached to a substrate.

9. The UV plastic object protection system of claim 8, wherein the substrate is attached to the exterior of the plastic object.

10. The UV plastic object protection system of claim 3, wherein the UV reflective material is comprised of barium sulfate.

11. The UV plastic object protection system of claim 1, wherein the UV reflective material is attached to the interior of the plastic object.

12. The UV plastic object protection system of claim 1, further comprising an edible material positioned within the interior of the plastic object.

13. The UV plastic object protection system of claim 12, wherein the edible material is comprised of a liquid.

14. The UV plastic object protection system of claim 13, wherein the edible material is comprised of water.

15. The UV plastic object protection system of claim 1, wherein the plastic object is comprised of a container.

16. The UV plastic object protection system of claim 15, wherein the plastic object is comprised of a bottle.

17. The UV plastic object protection system of claim 1, wherein the UV reflective material is comprised of barium sulfate.

18. The UV plastic object protection system of claim 1, wherein the UV reflective material is attached to a koozie, wherein the koozie removably surrounds the plastic object, wherein the UV reflective material is attached to an exterior surface of the koozie.

19. A UV plastic object protection system, comprising:
a plastic object comprising an exterior, wherein the plastic object is comprised of a plastic material;
a UV reflective material attached to the exterior of the plastic object, wherein the UV reflective material is adapted to reflect UV light away from the plastic object; and
wherein the UV reflective material is adapted to protect the exterior of the plastic object from exposure to UV light when the plastic object is exposed to UV light.

20. The UV plastic object protection system of claim 19, wherein the plastic object comprises a waterfowl decoy.
